(19) United States
(12) Patent Application Publication
(10) Pub. No.: US 2026/0362143 A1
(43) Pub. Date: Nov. 12, 2026

(54) USER EQUIPMENT (UE) ATTESTATION FOR WIRELESS COMMUNICATION

(71) Applicant: Lenovo (United States) Inc., Morrisville, NC (US)

(72) Inventors: Sheeba Backia Mary Baskaran, Friedrichsdorf (DE); Andreas Kunz, Ladenburg (DE)

(73) Assignee: Lenovo (United States) Inc., Morrisville, NC (US)

(21) Appl. No.: 19/204,210

(22) Filed: May 9, 2025

(51) Int. Cl. H04W 12/30; H04W 8/24; H04W 12/61

(52) U.S. Cl. CPC H04W 12/30; H04W 8/24; H04W 12/61

(57) ABSTRACT

Various aspects of the present disclosure relate to user equipment (UE) attestation for wireless communication. An apparatus, such as a UE, transmits a first message including one or more security attestation capabilities of the UE, and receives, based at least in part on the first message, a security attestation challenge including a freshness parameter. The UE transmits a security attestation response, where the security attestation response is generated based at least in part on the freshness parameter and one or more UE attestation claims.

### TECHNICAL FIELD

The present disclosure relates to wireless communications, and more specifically to security in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to transmit a first message including one or more security attestation capabilities of the UE; receive, based at least in part on the first message, a security attestation challenge including a freshness parameter; and transmit a security attestation response, where the security attestation response is generated based at least in part on the freshness parameter and one or more UE attestation claims.

A processor (e.g., a standalone processor chipset, or a component of a UE) for wireless communication is described. The processor may be configured to, capable of, or operable to perform one or more operations as described herein. For example, the processor may be configured to, capable of, or operable to transmit a first message including one or more security attestation capabilities of the UE; receive, based at least in part on the first message, a security attestation challenge including a freshness parameter; and transmit a security attestation response, where the security attestation response is generated based at least in part on the freshness parameter and one or more UE attestation claims.

A method performed or performable by a UE for wireless communication is described. The method may include transmitting a first message including one or more security attestation capabilities of the UE; receiving, based at least in part on the first message, a security attestation challenge including a freshness parameter; and transmitting a security attestation response, where the security attestation response is generated based at least in part on the freshness parameter and one or more UE attestation claims.

In some implementations of the UE, the processor, and the method described herein, the one or more security attestation capabilities of the UE include one or more of UE capability to generate UE attestation evidence generation, UE support of attestation security context generation, UE support of specific cryptographic algorithms, UE supported key size, or UE method of attestation evidence generation; the freshness parameter includes one or more of a timestamp, a random number, a counter value, or a nonce value; the one or more UE attestation claims include one or more of: UE identifier; Subscriber identifier; subscriber identity module (SIM) credentials; mobile equipment/mobile entity (ME) credentials; a security key; or UE user authentication information; the one or more UE attestation claims include one or more of: a service area code; radio access network (RAN) information; network slice selection information; subscription concealed identifier (SUCI) calculation information; or a routing indicator.

In some implementations of the UE, the processor, and the method described herein, the one or more UE attestation claims include one or more of: UE capabilities; UE mobility management capability information; UE radio capability information; UE security capability information; or ME capability information; the one or more UE attestation claims include one or more of: UE operating system (OS) information; UE application information; UE vendor information; UE software information; UE hardware information; UE firmware information; or UE artificial intelligence (AI)/machine learning (ML) model information; the security attestation response includes one or more, a signed version, or a token generated based at least in part on the one or more UE attestation claims.

In some implementations of the UE, the processor, and the method described herein, the UE, the processor, and the method may further be configured to, capable of, operable to, performed to, or performable to receive a notification associated with an attestation action, where the notification includes one of: an indication of access permission based on a successful attestation result; or an indication of a release of UE connectivity based on an attestation failure.

An NE (e.g., a base station) for wireless communication is described. The NE may be configured to, capable of, or operable to perform one or more operations as described herein. For example, the NE may be configured to, capable of, or operable to receive a first message including one or more security attestation capabilities of a UE; transmit a second message including the one or more security attestation capabilities and an identifier for the UE; receive, based at least in part on the second message, a security attestation challenge including a freshness parameter; and transmit, to the UE, the security attestation challenge.

A processor (e.g., a standalone processor chipset, or a component of a NE) for wireless communication is described. The processor may be configured to, capable of, or operable to perform one or more operations as described herein. For example, the processor may be configured to, capable of, or operable to receive a first message including one or more security attestation capabilities of a UE; transmit a second message including the one or more security attestation capabilities and an identifier for the UE; receive, based at least in part on the second message, a security attestation challenge including a freshness parameter; and transmit, to the UE, the security attestation challenge.

A method performed or performable by an NE (e.g., a base station) for wireless communication is described. The method may include receiving a first message including one or more security attestation capabilities of a UE; transmitting a second message including the one or more security attestation capabilities and an identifier for the UE; receiving, based at least in part on the second message, a security attestation challenge including a freshness parameter; and transmitting, to the UE, the security attestation challenge.

In some implementations of the NE, the processor, and the method described herein, the one or more security attestation capabilities of the UE include one or more of UE capability to generate UE attestation evidence generation, UE support of attestation security context generation, UE support of specific cryptographic algorithms, UE supported key size, or UE method of attestation evidence generation.

In some implementations of the NE, the processor, and the method described herein, the NE, the processor, and the method may further be configured to, capable of, operable to, performed to, or performable to receive a security attestation response including one or more, a signed version, or a token generated based at least in part on the one or more UE attestation claims; transmit at least a portion of the security attestation response; and receive a security attestation verification result indicating whether security attestation of the UE is successful; transmit, based at least in part on the security attestation verification result, a notification associated with an attestation action, where the notification includes one of: an indication of access permission based on a successful attestation result; or an indication of a release of UE connectivity based on an attestation failure.

An NE (e.g., a base station) for wireless communication is described. The NE may be configured to, capable of, or operable to perform one or more operations as described herein. For example, the NE may be configured to, capable of, or operable to receive a second message including one or more security attestation capabilities of a UE and an identifier for the UE; generate, based at least in part on receiving the second message, a security attestation challenge for the UE including a freshness parameter; and transmit the security attestation challenge.

A processor (e.g., a standalone processor chipset, or a component of a NE) for wireless communication is described. The processor may be configured to, capable of, or operable to perform one or more operations as described herein. For example, the processor may be configured to, capable of, or operable to receive a second message including one or more security attestation capabilities of a UE and an identifier for the UE; generate, based at least in part on receiving the second message, a security attestation challenge for the UE including a freshness parameter; and transmit the security attestation challenge.

A method performed or performable by an NE (e.g., a base station) for wireless communication is described. The method may include receiving a second message including one or more security attestation capabilities of a UE and an identifier for the UE; generating, based at least in part on receiving the second message, a security attestation challenge for the UE including a freshness parameter; and transmitting the security attestation challenge.

In some implementations of the NE, the processor, and the method described herein, the one or more security attestation capabilities of the UE include one or more of UE capability to generate UE attestation evidence generation, UE support of attestation security context generation, UE support of specific cryptographic algorithms, UE supported key size, or UE method of attestation evidence generation; the security attestation challenge is generated based at least in part on an attestation verification trigger; the attestation verification trigger is based at least in part on one or more of: an attestation policy; a periodic attestation indication; a time interval; a request from a different NE; UE analytics; or a UE authentication indication.

In some implementations of the NE, the processor, and the method described herein, the NE, the processor, and the method may further be configured to, capable of, operable to, performed to, or performable to receive a security attestation response; and transmit a security attestation verification result indicating whether security attestation of the UE is successful.

### BRIEF DESCRIPTION OF THE DRAWINGS

FIG. 1 illustrates an example of a wireless communications system in accordance with aspects of the present disclosure.

FIG. 2 illustrates an example system in accordance with aspects of the present disclosure.

FIGS. 3 and 4 illustrate an example system in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method in accordance with aspects of the present disclosure.

FIG. 9 illustrates a flowchart of a method in accordance with aspects of the present disclosure.

FIG. 10 illustrates a flowchart of a method in accordance with aspects of the present disclosure.

### DETAILED DESCRIPTION

In a wireless communications system, a UE and an NE (e.g., a base station, gNB) may support wireless communication (e.g., reception and/or transmission of wireless communication) using time-frequency resources. UE security is an important consideration in allowing UE access to time-frequency resources over a network. In some wireless communications networks, a UE can utilize subscriber credentials to access a network connection to consume communication services and/or third-party services offered using the wireless communications network connection. If the UE is compromised by a security attack, an attacker can gain control over the UE and can utilize established mobile network connections to launch cyber attacks over the network via the established UE network connection. In such scenarios, the compromised UE may be identified by the network after the UE starts sending abnormal messages towards the network. Abnormal messages may include messages that deviate from normal specified messages, e.g., sending excess number of messages to cause denial of services, sending malformed messages to hijack/cause network service failure. Abnormal messages may also occur where message validation or verification fails at the receiving network during a message integrity check, a confidentiality check, and/or where UE authentication verification fails or service authorization verification fails, e.g., where a UE requests unsubscribed services.

Thus, in some wireless communications systems, abnormal messages from the UE processed by the network (e.g., RAN node or network function (NF) or application function (AF)) can impact the network leading to network hijack or service failure due to flooding attack. In some wireless communications systems, there exists no standard mechanism to identify whether a UE is compromised, e.g., in advance of UE attempts at wireless communication over the network.

Aspects of the present disclosure are described in the context of a wireless communications system and include implementations that provide techniques for UE security attestation in wireless communications networks. For example, UE security attestation capabilities can be used to determine ways to perform UE attestation between different entities. Different UE attestation claims may also be used to verify whether a UE is in a trusted security state such that UE access to wireless network resources may be permitted.

By performing the described techniques, a wireless communications system can ensure the integrity of UEs to prevent unauthorized access to wireless communications resources (e.g., time/frequency resources), which may prevent malicious activities from occurring via the wireless communications resources.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

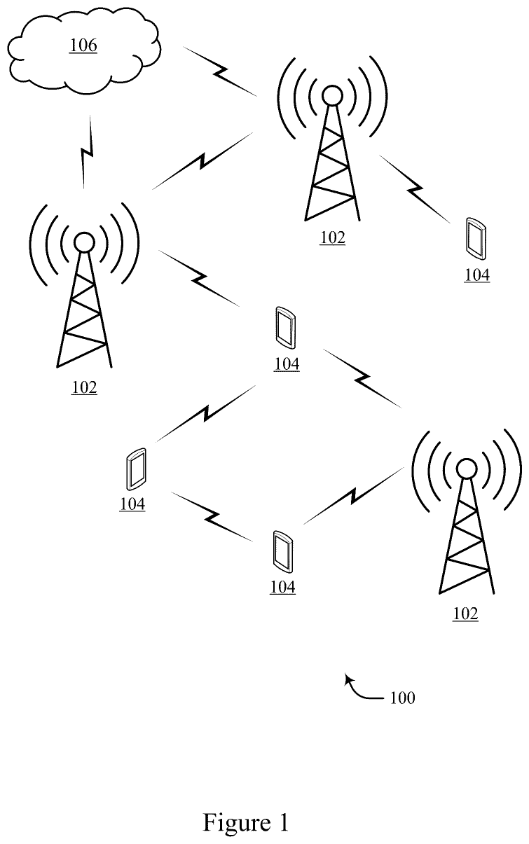

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, a NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the NEs 102 and the UEs 104 are operable to implement various aspects of the techniques described with reference to the present disclosure. For example, a UE 104 transmits, to a NE 102, a first message including one or more security attestation capabilities of the UE 104. The UE 104 receives, based at least in part on the first message, a security attestation challenge including a freshness parameter, and transmits a security attestation response, where the security attestation response is generated based at least in part on the freshness parameter and one or more UE attestation claims.

An NE 102 (e.g., a base station, gNB) receives a first message including one or more security attestation capabilities of a UE, and transmits a second message including the one or more security attestation capabilities and an identifier for the UE. The NE 102 receives, based at least in part on the second message, a security attestation challenge including a freshness parameter, and transmits, to a UE 1-4, the security attestation challenge.

An NE 102 (e.g., a base station, gNB) receives a second message including one or more security attestation capabilities of a UE and an identifier for the UE. The NE 102 generates, based at least in part on receiving the second message, a security attestation challenge for the UE including a freshness parameter, and transmits the security attestation challenge.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

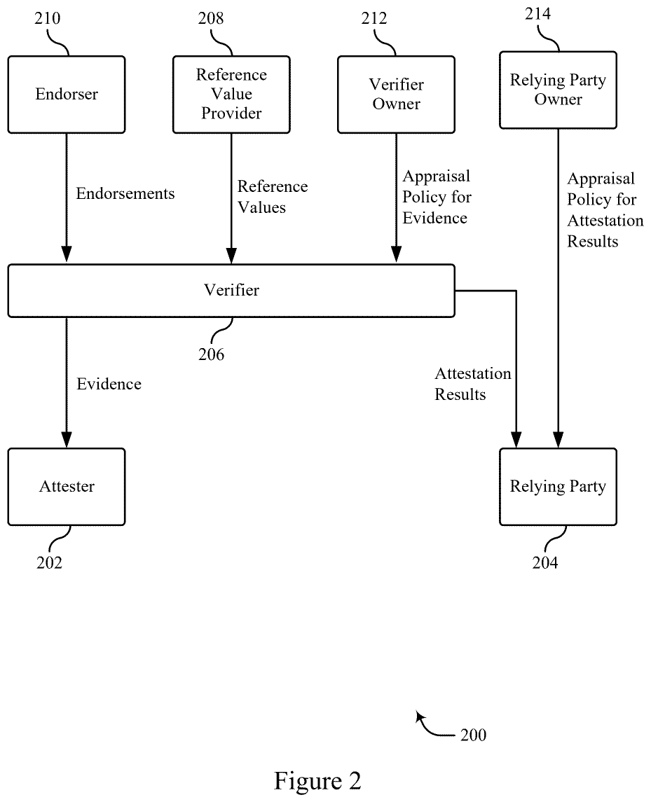

FIG. 2 illustrates an example system 200 in accordance with aspects of the present disclosure. The system 200, for example, illustrates an example architecture for remote attestation procedures. With reference to remote attestation procedures, information of an operating state can be useful. Accordingly, the system 200 provides an architectural overview of entities involved in remote attestation, e.g., through the process of generating, conveying, and evaluating evidentiary attestation claims. In some examples, the system 200 is neutral regarding processor architectures, the content of attestation claims, and protocols.

In the system 200 for remote attestation procedures, an attester 202 (a first peer) produces information about itself (“Evidence”) to enable a relying party 204 (a remote peer) to determine whether to consider that the attester 202 is a trustworthy peer. Remote attestation procedures are facilitated by a verifier 206. The verifier 206 appraises the evidence via appraisal policies and creates attestation results to support the relying party 204 in a decision process. In some examples, topological patterns and the sequence of data flows associated with them, such as the “Passport Model” and the “Background-Check Model”, can be supported. The system 200 can be implemented to provide information about trust and trustworthiness. Trust can represent a determination about another system. Trustworthiness can represent a quality about the other system that can be used in making a decision to trust it or not.

In some examples, the attester 202 can represent entities that create evidence that is conveyed to the verifier 206. The verifier 206 can represent entities that use the evidence, reference values from a reference value provider 208, and endorsements from endorsers 210 by applying an appraisal policy for evidence to assess the trustworthiness of the attester 202. This procedure can be referred to as “appraisal of evidence”. Subsequently, the verifier 206 can generate attestation results for use by relying parties 204. The appraisal policy for evidence may be obtained from a verifier owner 212 via a protocol mechanism, configured into the verifier 206 by the verifier owner 212, programmed into the verifier 206, or obtained via a different mechanism.

The relying party 204 can represent an entity that uses attestation results by applying its own appraisal policy to make application-specific decisions, such as authorization decisions. This procedure can be referred to as “appraisal of attestation results”. The appraisal policy for attestation results may be obtained from a relying party owner 214 via a protocol mechanism, configured into the relying party 204 by the relying party owner 214, programmed into the relying party 204, or obtained via a different mechanism.

In some wireless communications systems, a system for remote attestation procedures may not describe the specific details of claims to be attested and verified for UE attestation/integrity verification related to telecommunications network service access, e.g., for 3GPP 5G/6G/next generation networks. Further, such systems may not describe which cryptographic keys can be used to perform attestation and attestation verification in the 3GPP 5G/6G/next generation networks.

Aspects of the present disclosure include solutions to perform UE attestation to verify UE integrity. Implementations describe UE attestation, which serves a critical role in wireless network security and zero-trust architectures, where novel aspects include a list of UE-related claims to be attested and verified, e.g., by an attestation service function (ATSF) in the network. Some of the UE claims which can be attested and verified to ensure the UE integrity can include:
SIM Credentials
ME credentials e.g., NPN credentials, 3^{rd} party service security credentials, service security credentials.
Secret key, international mobile subscriber identity (IMSI)/network access identifier (NAI), any UE identifier (ID)
Home network (HN) public key, HN public key ID, protection scheme identifier,
Service area code and candidate RAN ID list (gNB ID)
NOTE: Service area code and candidate RAN ID list (gNB ID) can be alternatively Tracking area code and configured allowed RAN ID and access radio access technology (e.g., 3G/4G/5G/6G/any next generation code).
Configured Network slice selection assistance information
SUCI calculation indication
Routing Indicator
UE Equipment Information/PEI/international mobile equipment identity (IMEI) or a wildcard IDs
UE mobility management capabilities
UE radio capabilities
UE Security capabilities, e.g., supported cryptographic algorithms identifiers, key sizes, cryptographic operation modes e.g., related to ciphering/encryption and integrity protection (related to algorithms such as advanced encryption standard (AES), ZUC, Snow3G, authenticated encryption with associated data (AEAD), and post quantum cryptographic algorithms, etc.), quantum bits generator supported or not.
UE capabilities
ME Security capabilities
ME Capabilities
OS Information/version
App ID(s) and Application packages
Vendor information or vendor name or version
UE software information
UE hardware information
UE firmware information
User authentication results (e.g., fast identity online (FIDO) results)
Configured AI/ML Models (e.g., AI/ML model files) and Model parameters along with related application/service information is applicable.

Implementations also provide attestation security context generation and usage between the UE and network to allow evidence signing/hashing at an attester environment/UE, and related evidence verification at the network. Implementations describe how the UE or any device in a telecommunications network (e.g., 5G/6G/Next generation system) can be attested and verified by the network to check the trustworthiness and integrity of the device/UE system state/security state to determine whether the system state/security state is compromised, and to allow or deny further network/service connections and related access.

In some implementations, UE attestation can provide cryptographic proof that a device (UE) is trustworthy—e.g., that the UE is running genuine, untampered software and hardware, and is in a secure state. Example purposes of UE attestation include:

Device Integrity Verification: The described attestation verification function (ATVF) service can determine whether a UE has been compromised (e.g., rooted or jailbroken) and is operating as intended by using an attestation security context.

Secure Network Access Control: Attestation can enable network to determine whether to grant access to sensitive services or data based on UE trust status. A wireless communications system can determine, based on attestation results, actions such as (i) if the UE can connect to the network or not, or an ongoing connection should be released; (ii) if the UE can establish a service connection to a network service or third party service or not, or an ongoing connection should be released; and/or (iii) if the UE can establish a data connection to a network service or application service or third party service or not, or an ongoing connection should be released, etc.

Compliance Enforcement: Attestation can enable operators or enterprises to enforce security policies (e.g., allowing devices with updated OS or approved configurations, correct security capabilities) based on the attestation results.

Support for Zero Trust Architecture: In zero trust, no device is inherently trusted. Attestation enables continuous, dynamic evaluation of trust before and during access.

Trusted execution environments (TEE)/secure enclave/secure element/trusted platform module (TPM) verification: Attestations can confirm that sensitive operations are performed within a protected and verified TEE/secure environment (SE)/TPM.

Remote Attestation: Allows external entities (e.g., cloud services, network operators, third party service providers) to verify the integrity of the UE without physical access.

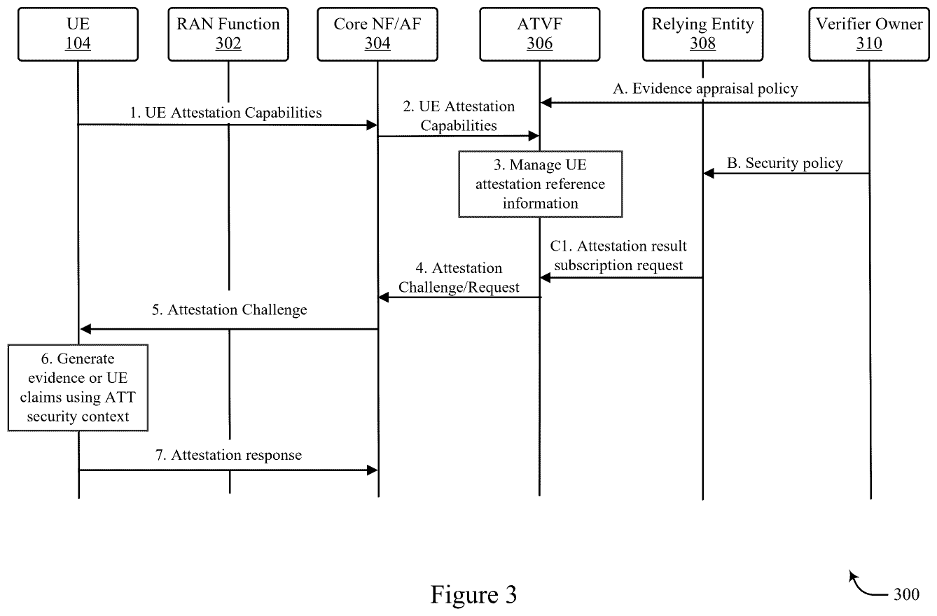

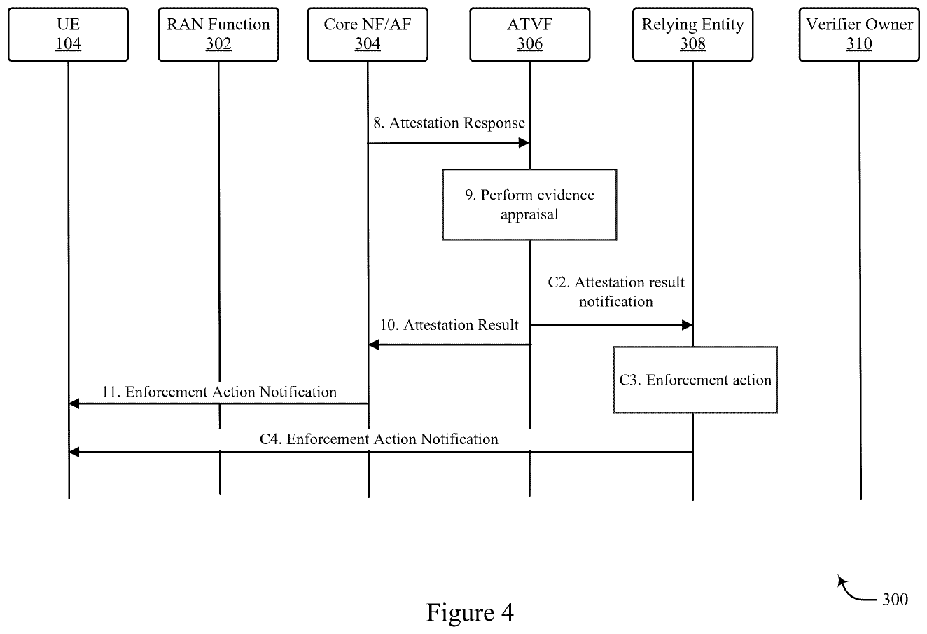

FIGS. 3 and 4 illustrate an example system 300 in accordance with aspects of the present disclosure. The system 300, for example, describes an example UE attestation procedure in accordance with one or more implementations. The system 300 may include the following devices/entities: UE 104, which may include an attester, TEE, SE, SIM, universal integrated circuit card (UICC), and/or an endorser; RAN function 302; core NF/AF 304; ATVF 306, which may represent an mobile network operator (MNO), a service provider NF/AF, and/or a verifier; a relying entity 308, which may represent a NF, AF, RAN, other UE; and a verifier owner 310, which may represent operations, administration and management/maintenance (OAM), security management, unified data management (UDM), policy control function (PCF).

In the system 300, at Step A the verifier owner 310 may communicate to the ATVF 306 an evidence appraisal policy for UE attestation, which may describe an attestation result related recommended action. Step A may represent attestation evidence appraisal policy provisioning. The verifier owner 310 and/or other management function can send the UE evidence appraisal policy for the UE attestation to the ATVF 306 or other function in the MNO or service provider domain in a 3GPP network which can perform attestation functions. The UE evidence appraisal policy can include one or more of: Evidence appraisal policy ID, target device/UE ID, reference values/expected values or range of reference values/expected values (e.g., as key-value pair such as UE configuration name and UE configuration value related to the list of UE claims), hash/signed expected reference values/expected values, etc. The hash/signed expected reference values/expected values can be hashed or signed and provided to a management function either by the UE or an application server offered by the operator or vendor related to the UE attestation service after a user consent check and authorization from the user/subscriber.

The UE evidence appraisal policy can be related to the UE attestation result handling, for example: If a key value pair matches the attested claims/evidence of the UE, the attestation verification result can be considered as successful; or if a key value pair does not match the attested claims/evidence of the UE, the attestation verification result can be considered as unsuccessful or failure. In some implementations, the UE evidence appraisal can be in a key-Value pair format, e.g., as illustrated in Table 1:

TABLE 1

| Key (Information | |
|---|---|
| name) | Expected Value(s) |
| UE ID | Excepted value of UE ID e.g., IMSI/NAI/ |
| | subscription permanent identifier (SUPI)/ |
| | Digital ID/Digital SUPI |
| Attestation Security | A key used to verify evidence related to the |
| context | attestation verification. |
| | Example: Attestation public key (if asymmetric |
| | key is used) (or) |
| | Attestation security key ATT_key (if |
| | symmetric key is used) |
| ME credentials | Excepted value of ME credentials e.g., NPN |
| | credentials, 3^{rd} party service security |
| | credentials, service security credentials. |
| UE Security context | Excepted value such as Secret key, IMSI/NAI, |
| | any UE ID |
| Network provisioned | Excepted value such as HN public key, HN |
| security information or | public key id, protection scheme identifier, |
| UE privacy protection | |
| information | |
| UE Radio access | Excepted value such as Service area code and |
| information | candidate RAN ID list (gNB ID) |
| | NOTE: Service area code and candidate RAN |
| | ID list (gNB ID) can be alternatively Tracking |
| | area code and configured allowed RAN ID and |
| | access radio access technology (e.g., |
| | 3G/4G/5G/6G/any next generation code). |
| Slice Information | Excepted value such as Configured Network |
| | slice selection assistance information |
| UE ID privacy support | Excepted value such as SUCI calculation |
| information | indication |
| UE routing | Excepted value such as Routing Indicator |
| information | |
| UE device information | Excepted value such as UE Equipment |
| | Information/permanent equipment identifier |
| | (PEI)/IMEI or a wildcard IDs |
| UE mobility management | Excepted values related to UE mobility |
| information | management capabilities |
| UE radio information | Excepted values related to UE radio capabilities |
| UE security capabilities | Excepted values related to UE Security |
| | capabilities, e.g., supported cryptographic |
| | algorithms identifiers, key sizes, cryptographic |
| | operation modes e.g., related to |
| | ciphering/encryption and integrity protection |
| | (related to both legacy algorithms such AES, |
| | ZUC, Snow3G, AEAD, and post quantum |
| | cryptographic algorithms etc.), Quantum bits |
| | generator supported or not. |
| UE capabilities | Excepted values related to UE capabilities |
| Device security | Excepted values related to ME Security |
| capabilities | capabilities |
| Device capabilities | Excepted values related to ME Capabilities |
| OS information | Excepted values related to OS |
| | Information/version |
| Application information | Excepted values related to App ID(s) and |
| | Application packages |
| Vendor information | Excepted values related to Vendor |
| | information/configurations or vendor name or |
| | version |
| UE software information | Excepted values related to UE software |
| | information |
| UE hardware information | Excepted values related to UE hardware |
| | information |
| UE firmware information | Excepted values related to UE firmware |
| | information |
| User authentication or | Excepted values related to User authentication |
| authorization information | results (e.g., FIDO results) |

At Step B, attestation security policy provisioning for enforcement actions related to attestation results is performed from the verifier owner 310 to the relying entity 308. The verifier owner 310 and/or other management function in a wireless communications system may perform the role of verifier owner and provides the security policy to enforce or activate attestation result-related actions at the ATVF 306 or other function in the MNO or service provider domain in the 3GPP. The ATVF 306 may perform an attestation function in scenarios where the recommended actions related to each attestation result are to be sent/notified to the relying entity 308 such as NFs or RAN nodes/RAN functions/AF/UEs. Alternatively, or in addition, the security policy to enforce or activate attestation result-related actions can be provided to the relying entity 308, e.g., if a UE attestation result is failure, then possible recommended actions at the core NF/AF 304 can be UE connection release.

In some implementations, the UE attestation related security policy can be related to the UE attestation result handling, and in one example: If the attestation verification result is successful, allow a UE service connection/data connection/network connection, and/or consider the UE authentication as successful; or if the attestation verification result is unsuccessful, deny a UE service connection/data connection/network connection, and/or consider that the UE authentication is unsuccessful.

In the system 300, at Step 1: The UE 104 communicates UE attestation capabilities to the core NF/AF 304 (e.g., if the UE 104 is to communicate with the ATVF 306 indirectly via the core NF/AF 304). The UE attestation capabilities can be communicated in different ways, such as an NAS message, a service message, an application message, and via the RAN function 302. Alternatively, or in addition, the UE 104 may directly communicate UE attestation capabilities and a UE ID to the ATVF 306 in a service message and/or application message.

At Step 2: The core NF/AF 304 (alternatively, the ATVF 306) communicates the UE attestation capabilities and UE ID to the ATVF 306. The ATVF 306 stores the UE attestation capabilities and checks if it has the related evidence appraisal policy available, and if not, the ATVF 306 fetches the UE ID related evidence appraisal policy from a management function. The security establishment between the UE 104 and the network following the primary authentication can be assumed to have previously occurred.

At Step 3: The ATVF 306 manages UE attestation reference information (e.g., as endorsement information or the evidence appraisal policy as described and shown in Table 1). The ATVF 306 may also manage or derive UE attestation reference information. The ATVF 306 may determine to perform attestation based on different events. The ATVF may trigger attestation verification based on one or more of the following: a. Based on local policies; b. On a periodic or time interval basis; c. On request from other NF/AF (e.g., serving the UE 104); d. Based on abnormal behavior analytics of the UE 104 (e.g., due to abnormal messages received from the UE 104); e. During UE authentication or following a successful UE authentication to confirm successful UE authentication.

At step 4: The ATVF 306 communicates to the core NF/AF 304 the attestation challenge with the freshness parameter, where the freshness parameter can include one or more of a timestamp value, a random number, a counter value, or a nonce number. At Step 5: The core NF/AF 304 communicates the attestation challenge with the freshness parameter to the UE 104. At Step 6: The UE 104 generates evidence and/or UE claims using attestation (ATT) security context. For example, the UE 104 generates the attestation security context such as ATT_Key if evidence/claims hash are to be generated, or the UE 104 uses an available ATT_Key pair (if configured/provisioned in the UE/universal subscriber identity module (USIM)/UICC/other secure element) to sign the evidence/claims with the public key (e.g., ATT_pubkey).

Regarding attestation security context generation and usage, attestation key generation can be performed using the following options, e.g., based on the UE configuration: Option 1: Attestation public, private key pair exists as part of SIM credentials or in TEE/SE or in the attestation environment. The private key may be used to sign the UE claims by the UE and the related public key may be used to verify the sign at the network side; Option 2: HN public key may be used to encrypt the attestation evidence; Option 3: An attestation key may be generated from the SIM credentials and used to generate a message authentication code (MAC) of the attestation evidence. ATT_Key: key derivation function (KDF) (secret K/anchor key/other key derived from K, attestation purpose, UE ID, freshness parameter).

UE claims used for evidence generation for attestation of UE security state/UE system state can include the following parameters as values or as key value pairs. Some of the UE claims which can be attested and verified to ensure the UE integrity can include the following:
SIM Credentials
ME credentials e.g., NPN credentials, 3^{rd} party service security credentials, service security credentials
Secret key, IMSI/NAI, UE ID
HN public key, HN public key ID, protection scheme identifier
Service area code and candidate RAN ID list (gNB ID)
   Service area code and candidate RAN ID list (gNB ID) can be tracking area code and configured allowed RAN ID and access radio access technology (e.g., 3G/4G/5G/6G/next generation code).
Configured Network slice selection assistance information
SUCI calculation indication
Routing Indicator
UE Equipment Information/PEI/IMEI or a wildcard IDs
UE mobility management capabilities
UE radio capabilities
UE Security capabilities e.g., supported cryptographic algorithms identifiers, key sizes, cryptographic operation modes e.g., related to ciphering/encryption and integrity protection (related to both legacy algorithms such AES, ZUC, Snow3G, AEAD, and post quantum cryptographic algorithms etc.), Quantum bits generator supported or not.
UE capabilities
ME Security capabilities
ME Capabilities
OS Information/version
App ID and Application packages
Vendor information or vendor name or version
UE software information
UE hardware information
UE firmware information
User authentication results (e.g., FIDO results)
Configured AI/ML Models (e.g., AI/ML model files) and Model parameters along with related application/service information are applicable.

In the system 300, at Step 7: The UE 104 communicates an attestation challenge response to the core NF/AF 304. The attestation challenge response may include attestation evidence, e.g., hash of UE claims, signed UE claims, signed UE claims as java web token (JWT) token (where each claim can be related to the key value pair listed in Table 1), UE ID, etc. At Step 8: The core NF/AF 304 may communicate the attestation challenge response to the ATVF 306. The attestation challenge response may include the attestation evidence, e.g., hash of UE claims, signed UE claims, signed UE claims as JWT token, UE ID, etc.

At Step 9: The ATVF 306 may perform attestation evidence appraisal. The ATVF 306 may derive the attestation security context or use the attestation security context already available or configured similar to the UE 104 (e.g., as described in Step 5) to verify the MAC/hash if the hash of evidence is received by using ATT_Key. Alternatively, or in addition, the ATVF may verify the signature of the evidence using the ATT_pubkey related to the UE ID, or decrypt and check the evidence claims by using ATT_private key of the network/ATVF. At Step 10: The ATVF 306 communicates the attestation verification result or notification message to the core NF/AF 304, including UE ID, success or failure of attestation, and evidence details regarding recommended actions based on a result of attestation. At Step 11: The core NF/AF 304 performs an enforcement action, e.g., release the UE connection if the attestation result is failure or the allow service access/network access/considers UE authentication as successful if the attestation result is successful based on the security policy.

In some implementations, Steps C1-C4 represent ATVF 306 service subscription and notification to enable attestation results-based access control at the network. At Step C1: The relying entity 308 can subscribe to the ATVF 306 by sending an attestation result/status subscription request to the ATVF 306, which can include the target UE ID for the UE 104, and notification endpoint ID/address. At Step C2: The ATVF 306 may perform UE attestation, and the ATVF 306 can notify the relying entity 308 (e.g., serving NF/AF/RAN node) of wireless communications network access/non-access) by sending the attestation result notification/response message, which may include the UE ID, success or failure indications, evidence details, and recommended actions. At Step C3: The relying entity 308 (e.g., serving NF/AF/RAN/UE node) determines to enforce an action as per the recommended action towards the UE 104 based on the attestation results. At Step C4: The relying entity 308 node performs the enforcement action, e.g., the relying entity 308 releases the UE connection if the attestation result is failure or allows service access/network access/considers UE authentication as successful if the attestation result is successful.

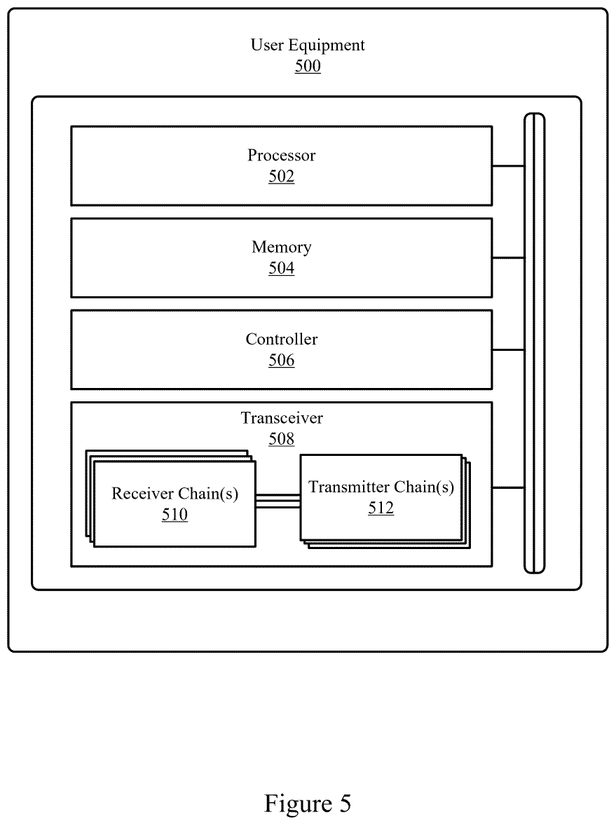

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for transmitting a first message including one or more security attestation capabilities of the UE; receiving, based at least in part on the first message, a security attestation challenge including a freshness parameter; and transmitting a security attestation response, where the security attestation response is generated based at least in part on the freshness parameter and one or more UE attestation claims.

Additionally, the UE 500 may be configured to support any one or combination of where the one or more security attestation capabilities of the UE include one or more of UE capability to generate UE attestation evidence generation, UE support of attestation security context generation, UE support of specific cryptographic algorithms, UE supported key size, or UE method of attestation evidence generation; the freshness parameter includes one or more of a timestamp, a random number, a counter value, or a nonce value; the one or more UE attestation claims include one or more of: UE identifier; subscriber identifier; SIM credentials; ME credentials; a security key; or UE user authentication information; the one or more UE attestation claims include one or more of: a service area code; radio access network (RAN) information; network slice selection information; SUCI calculation information; or a routing indicator, the one or more UE attestation claims include one or more of: UE capabilities; UE mobility management capability information; UE radio capability information; UE security capability information; or ME capability information; the one or more UE attestation claims include one or more of: UE operating system (OS) information; UE application information; UE vendor information; UE software information; UE hardware information; UE firmware information; or UE AI/ML model information; the security attestation response includes one or more, a signed version, or a token generated based at least in part on the one or more UE attestation claims; receiving a notification associated with an attestation action, where the notification includes one of: an indication of access permission based on a successful attestation result; or an indication of a release of UE connectivity based on an attestation failure.

Additionally, or alternatively, the UE 500 may support at least one memory (e.g., the memory 504) and at least one processor (e.g., the processor 502) coupled with the at least one memory and configured to cause the UE to transmit a first message including one or more security attestation capabilities of the UE; receive, based at least in part on the first message, a security attestation challenge including a freshness parameter; and transmit a security attestation response, where the security attestation response is generated based at least in part on the freshness parameter and one or more UE attestation claims.

Additionally, the UE 500 may be configured to support any one or combination of where the one or more security attestation capabilities of the UE include one or more of UE capability to generate UE attestation evidence generation, UE support of attestation security context generation, UE support of specific cryptographic algorithms, UE supported key size, or UE method of attestation evidence generation; the freshness parameter includes one or more of a timestamp, a random number, a counter value, or a nonce value; the one or more UE attestation claims include one or more of: UE identifier; Subscriber identifier; SIM credentials; ME credentials; a security key; or UE user authentication information; the one or more UE attestation claims include one or more of: a service area code; radio access network (RAN) information; network slice selection information; SUCI calculation information; or a routing indicator, the one or more UE attestation claims include one or more of: UE capabilities; UE mobility management capability information; UE radio capability information; UE security capability information; or ME capability information; the one or more UE attestation claims include one or more of: UE operating system (OS) information; UE application information; UE vendor information; UE software information; UE hardware information; UE firmware information; or UE AI/ML model information; the security attestation response includes one or more, a signed version, or a token generated based at least in part on the one or more UE attestation claims; the at least one processor is operable to cause the UE to: receive a notification associated with an attestation action, where the notification includes one of: an indication of access permission based on a successful attestation result; or an indication of a release of UE connectivity based on an attestation failure.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

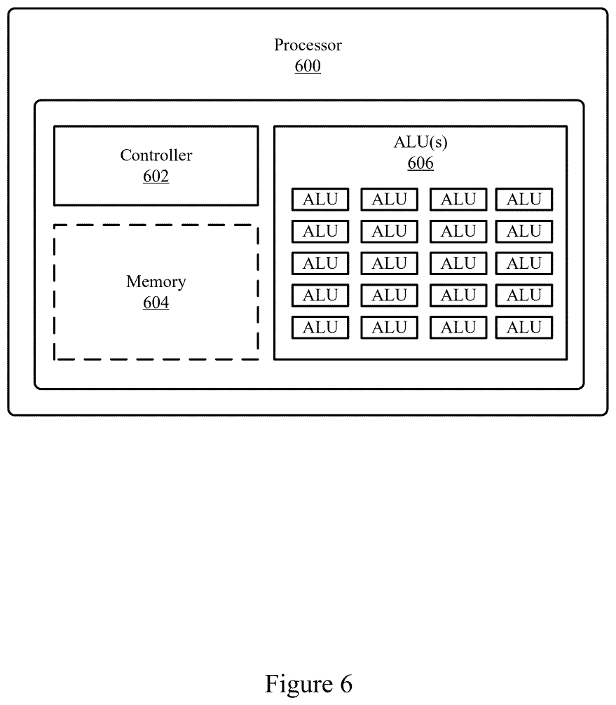

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to transmit a first message including one or more security attestation capabilities of the UE; receive, based at least in part on the first message, a security attestation challenge including a freshness parameter; and transmit a security attestation response, where the security attestation response is generated based at least in part on the freshness parameter and one or more UE attestation claims.

Additionally, the processor 600 may be configured to or operable to support any one or combination of where the one or more security attestation capabilities of the UE include one or more of UE capability to generate UE attestation evidence generation, UE support of attestation security context generation, UE support of specific cryptographic algorithms, UE supported key size, or UE method of attestation evidence generation; the freshness parameter includes one or more of a timestamp, a random number, a counter value, or a nonce value; the one or more UE attestation claims include one or more of: UE identifier; Subscriber identifier; SIM credentials; ME credentials; a security key; or UE user authentication information; the one or more UE attestation claims include one or more of: a service area code; radio access network (RAN) information; network slice selection information; SUCI calculation information; or a routing indicator, the one or more UE attestation claims include one or more of: UE capabilities; UE mobility management capability information; UE radio capability information; UE security capability information; or ME capability information; the one or more UE attestation claims include one or more of: UE operating system (OS) information; UE application information; UE vendor information; UE software information; UE hardware information; UE firmware information; or UE AI/ML model information; the security attestation response includes one or more, a signed version, or a token generated based at least in part on the one or more UE attestation claims; the at least one controller is operable to cause the processor to: receive a notification associated with an attestation action, where the notification includes one of: an indication of access permission based on a successful attestation result; or an indication of a release of UE connectivity based on an attestation failure.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to receive a first message including one or more security attestation capabilities of a UE; transmit a second message including the one or more security attestation capabilities and an identifier for the UE; receive, based at least in part on the second message, a security attestation challenge including a freshness parameter; and transmit, to the UE, the security attestation challenge.

Additionally, the processor 600 may be configured to or operable to support any one or combination of where the one or more security attestation capabilities of the UE include one or more of UE capability to generate UE attestation evidence generation, UE support of attestation security context generation, UE support of specific cryptographic algorithms, UE supported key size, or UE method of attestation evidence generation; receive a security attestation response including one or more, a signed version, or a token generated based at least in part on the one or more UE attestation claims; transmit at least a portion of the security attestation response; and receive a security attestation verification result indicating whether security attestation of the UE is successful; transmit, based at least in part on the security attestation verification result, a notification associated with an attestation action, where the notification includes one of: an indication of access permission based on a successful attestation result; or an indication of a release of UE connectivity based on an attestation failure.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to receive a second message including one or more security attestation capabilities of a UE and an identifier for the UE; generate, based at least in part on receiving the second message, a security attestation challenge for the UE including a freshness parameter; and transmit the security attestation challenge.

Additionally, the processor 600 may be configured to or operable to support any one or combination of where the one or more security attestation capabilities of the UE include one or more of UE capability to generate UE attestation evidence generation, UE support of attestation security context generation, UE support of specific cryptographic algorithms, UE supported key size, or UE method of attestation evidence generation; the security attestation challenge is generated based at least in part on an attestation verification trigger; the attestation verification trigger is based at least in part on one or more of: an attestation policy; a periodic attestation indication; a time interval; a request from a different NE; UE analytics; or a UE authentication indication; the at least one controller is operable to cause the processor to: receive a security attestation response; and transmit a security attestation verification result indicating whether security attestation of the UE is successful.

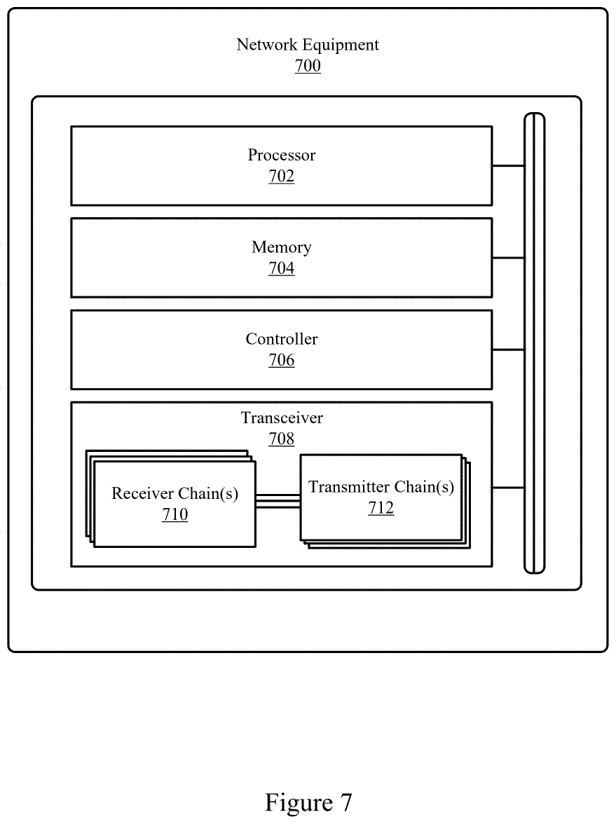

FIG. 7 illustrates an example of an NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for receiving a first message including one or more security attestation capabilities of a UE; transmitting a second message including the one or more security attestation capabilities and an identifier for the UE; receiving, based at least in part on the second message, a security attestation challenge including a freshness parameter; and transmit, to the UE, the security attestation challenge.

Additionally, the NE 700 may be configured to or operable to support any one or combination of where the one or more security attestation capabilities of the UE include one or more of UE capability to generate UE attestation evidence generation, UE support of attestation security context generation, UE support of specific cryptographic algorithms, UE supported key size, or UE method of attestation evidence generation; receiving a security attestation response including one or more, a signed version, or a token generated based at least in part on the one or more UE attestation claims; transmitting at least a portion of the security attestation response; and receiving a security attestation verification result indicating whether security attestation of the UE is successful; transmitting, based at least in part on the security attestation verification result, a notification associated with an attestation action, where the notification includes one of: an indication of access permission based on a successful attestation result; or an indication of a release of UE connectivity based on an attestation failure.

Additionally, or alternatively, the NE 700 may support at least one memory (e.g., the memory 704) and at least one processor (e.g., the processor 702) coupled with the at least one memory and configured to cause the NE to receive a first message including one or more security attestation capabilities of a UE; transmit a second message including the one or more security attestation capabilities and an identifier for the UE; receive, based at least in part on the second message, a security attestation challenge including a freshness parameter; and transmit, to the UE, the security attestation challenge.

Additionally, the NE 700 may be configured to support any one or combination of where the one or more security attestation capabilities of the UE include one or more of UE capability to generate UE attestation evidence generation, UE support of attestation security context generation, UE support of specific cryptographic algorithms, UE supported key size, or UE method of attestation evidence generation; receive a security attestation response including one or more, a signed version, or a token generated based at least in part on the one or more UE attestation claims; transmit at least a portion of the security attestation response; and receive a security attestation verification result indicating whether security attestation of the UE is successful; transmit, based at least in part on the security attestation verification result, a notification associated with an attestation action, where the notification includes one of: an indication of access permission based on a successful attestation result; or an indication of a release of UE connectivity based on an attestation failure.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for receiving a second message including one or more security attestation capabilities of a UE and an identifier for the UE; generating, based at least in part on receiving the second message, a security attestation challenge for the UE including a freshness parameter; and transmitting the security attestation challenge.

Additionally, the NE 700 may be configured to or operable to support any one or combination of where the one or more security attestation capabilities of the UE include one or more of UE capability to generate UE attestation evidence generation, UE support of attestation security context generation, UE support of specific cryptographic algorithms, UE supported key size, or UE method of attestation evidence generation; the security attestation challenge is generated based at least in part on an attestation verification trigger; the attestation verification trigger is based at least in part on one or more of: an attestation policy; a periodic attestation indication; a time interval; a request from a different NE; UE analytics; or a UE authentication indication; receiving a security attestation response; and transmitting a security attestation verification result indicating whether security attestation of the UE is successful.

Additionally, or alternatively, the NE 700 may support at least one memory (e.g., the memory 704) and at least one processor (e.g., the processor 702) coupled with the at least one memory and configured to cause the NE to receive a second message including one or more security attestation capabilities of a UE and an identifier for the UE; generate, based at least in part on receiving the second message, a security attestation challenge for the UE including a freshness parameter; and transmit the security attestation challenge.

Additionally, the NE 700 may be configured to support any one or combination of where the one or more security attestation capabilities of the UE include one or more of UE capability to generate UE attestation evidence generation, UE support of attestation security context generation, UE support of specific cryptographic algorithms, UE supported key size, or UE method of attestation evidence generation; the security attestation challenge is generated based at least in part on an attestation verification trigger; the attestation verification trigger is based at least in part on one or more of: an attestation policy; a periodic attestation indication; a time interval; a request from a different NE; UE analytics; or a UE authentication indication; the at least one processor is operable to cause the NE to: receive a security attestation response; and transmit a security attestation verification result indicating whether security attestation of the UE is successful.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

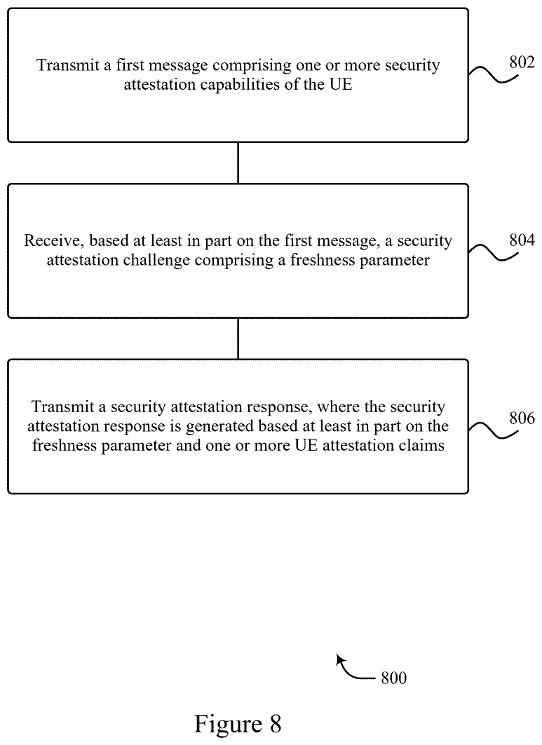

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include transmitting a first message including one or more security attestation capabilities of the UE. The operations of 802 may be performed in accordance with examples as described herein. In some implementations, aspects of the operations of 802 may be performed by a UE as described with reference to FIG. 5.

At 804, the method may include receiving, based at least in part on the first message, a security attestation challenge including a freshness parameter. The operations of 804 may be performed in accordance with examples as described herein. In some implementations, aspects of the operations of 804 may be performed by a UE as described with reference to FIG. 5.

At 806, the method may include transmitting a security attestation response, where the security attestation response is generated based at least in part on the freshness parameter and one or more UE attestation claims. The operations of 806 may be performed in accordance with examples as described herein. In some implementations, aspects of the operations of 806 may be performed a UE as described with reference to FIG. 5.

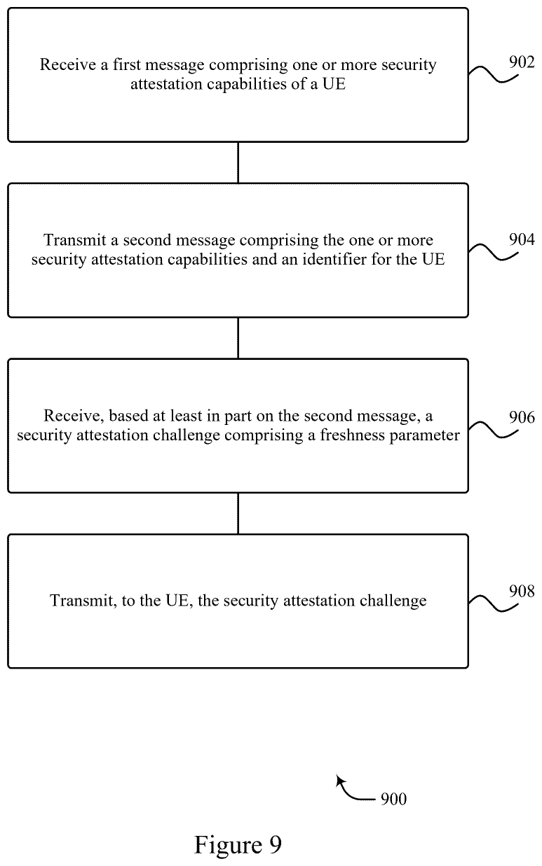

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include receiving a first message including one or more security attestation capabilities of a UE. The operations of 902 may be performed in accordance with examples as described herein. In some implementations, aspects of the operations of 902 may be performed by an NE as described with reference to FIG. 7.

At 904, the method may include transmitting a second message including the one or more security attestation capabilities and an identifier for the UE. The operations of 904 may be performed in accordance with examples as described herein. In some implementations, aspects of the operations of 904 may be performed by an NE as described with reference to FIG. 7.

At 906, the method may include receiving, based at least in part on the second message, a security attestation challenge including a freshness parameter. The operations of 906 may be performed in accordance with examples as described herein. In some implementations, aspects of the operations of 906 may be performed an NE as described with reference to FIG. 7.

At 908, the method may include transmitting, to the UE, the security attestation challenge. The operations of 908 may be performed in accordance with examples as described herein. In some implementations, aspects of the operations of 908 may be performed an NE as described with reference to FIG. 7.

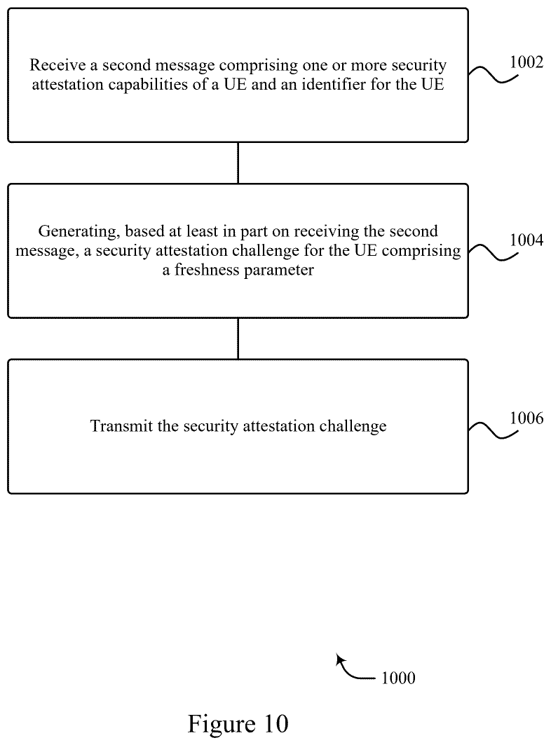

FIG. 10 illustrates a flowchart of a method 1000 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 1002, the method may include receiving a second message including one or more security attestation capabilities of a UE and an identifier for the UE. The operations of 1002 may be performed in accordance with examples as described herein. In some implementations, aspects of the operations of 1002 may be performed by an NE as described with reference to FIG. 7.

At 1004, the method may include generating, based at least in part on receiving the second message, a security attestation challenge for the UE including a freshness parameter. The operations of 1004 may be performed in accordance with examples as described herein. In some implementations, aspects of the operations of 1004 may be performed by an NE as described with reference to FIG. 7.

At 1006, the method may include transmitting the security attestation challenge. The operations of 1006 may be performed in accordance with examples as described herein. In some implementations, aspects of the operations of 1006 may be performed an NE as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and operable to cause the UE to:
transmit a first message comprising one or more security attestation capabilities of the UE;
receive, based at least in part on the first message, a security attestation challenge comprising a freshness parameter; and
transmit a security attestation response, wherein the security attestation response is generated based at least in part on the freshness parameter and one or more UE attestation claims.

2. The UE of claim 1, wherein the one or more security attestation capabilities of the UE comprise one or more of UE capability to generate UE attestation evidence generation, UE support of attestation security context generation, UE support of specific cryptographic algorithms, UE supported key size, or UE method of attestation evidence generation.

3. The UE of claim 1, wherein the freshness parameter comprises one or more of a timestamp, a random number, a counter value, or a nonce value.

4. The UE of claim 1, wherein the one or more UE attestation claims comprise one or more of:
UE identifier;
Subscriber identifier;
subscriber identity module (SIM) credentials;
ME credentials;
a security key; or
UE user authentication information.

5. The UE of claim 1, wherein the one or more UE attestation claims comprise one or more of:
a service area code;
radio access network (RAN) information;
network slice selection information;
subscription concealed identifier (SUCI) calculation information; or
a routing indicator.

6. The UE of claim 1, wherein the one or more UE attestation claims comprise one or more of:
UE capabilities;
UE mobility management capability information;
UE radio capability information;
UE security capability information; or
ME capability information.

7. The UE of claim 1, wherein the one or more UE attestation claims comprise one or more of:
UE operating system (OS) information;
UE application information;
UE vendor information;
UE software information;
UE hardware information;
UE firmware information; or
UE artificial intelligence (AI)/machine learning (ML) model information.

8. The UE of claim 1, wherein the security attestation response comprises one or more of a hash value of the one or more UE attestation claims, a signed version of the one or more UE attestation claims, or a token generated based at least in part on the one or more UE attestation claims.

9. The UE of claim 1, wherein the at least one processor is operable to cause the UE to:
receive a notification associated with an attestation action, wherein the notification comprises one of:
an indication of access permission based on a successful attestation result; or
an indication of a release of UE connectivity based on an attestation failure.

10. A first network equipment (NE) for wireless communication, comprising:
at least one memory; and
at least one processor coupled with the at least one memory and operable to cause the first NE to:
receive a first message comprising one or more security attestation capabilities of a user equipment (UE);
transmit a second message comprising the one or more security attestation capabilities and an identifier for the UE;
receive, based at least in part on the second message, a security attestation challenge comprising a freshness parameter; and
transmit, to the UE, the security attestation challenge.

11. The first NE of claim 10, wherein the one or more security attestation capabilities of the UE comprise one or more of UE capability to generate UE attestation evidence generation, UE support of attestation security context generation, UE support of specific cryptographic algorithms, UE supported key size, or UE method of attestation evidence generation.

12. The first NE of claim 10, wherein the at least one processor is operable to cause the first NE to:
receive a security attestation response comprising one or more of a hash value of one or more UE attestation claims, a signed version of the one or more UE attestation claims, or a token generated based at least in part on the one or more UE attestation claims.

13. The first NE of claim 12, wherein the at least one processor is operable to cause the first NE to:
transmit at least a portion of the security attestation response; and
receive a security attestation verification result indicating whether security attestation of the UE is successful.

14. The first NE of claim 13, wherein the at least one processor is operable to cause the first NE to:
transmit, based at least in part on the security attestation verification result, a notification associated with an attestation action, wherein the notification comprises one of:
an indication of access permission based on a successful attestation result; or
an indication of a release of UE connectivity based on an attestation failure.

15. A second network equipment (NE) for wireless communication, comprising:
at least one memory; and
at least one processor coupled with the at least one memory and operable to cause the second NE to:
receive a second message comprising one or more security attestation capabilities of a user equipment (UE) and an identifier for the UE;
generate, based at least in part on receiving the second message, a security attestation challenge for the UE comprising a freshness parameter; and
transmit the security attestation challenge.

16. The second NE of claim 15, wherein the one or more security attestation capabilities of the UE comprise one or more of UE capability to generate UE attestation evidence generation, UE support of attestation security context generation, UE support of specific cryptographic algorithms, UE supported key size, or UE method of attestation evidence generation.

17. The second NE of claim 15, wherein the security attestation challenge is generated based at least in part on an attestation verification trigger.

18. The second NE of claim 17, wherein the attestation verification trigger is based at least in part on one or more of:
an attestation policy;
a periodic attestation indication;
a time interval;
a request from a different NE;
UE analytics; or
a UE authentication indication.

19. The second NE of claim 15, wherein the at least one processor is operable to cause the second NE to:
receive a security attestation response; and
transmit a security attestation verification result indicating whether security attestation of the UE is successful.

20. A method performed by a user equipment (UE), the method comprising:
transmitting a first message comprising one or more security attestation capabilities of the UE;
receiving, based at least in part on the first message, a security attestation challenge comprising a freshness parameter; and
transmitting a security attestation response, wherein the security attestation response is generated based at least in part on the freshness parameter and one or more UE attestation claims.
